(19) United States
(12) Patent Application Publication
(10) Pub. No.: US 2008/0033876 A1
(43) Pub. Date: Feb. 7, 2008

(54) Interactive reports

(76) Inventors: Beth Goldman, San Francisco, CA (US); Hector Simon Lopez, Sausalito, CA (US); Suzanne Y. Pellican, Menlo Park, CA (US); Joseph W. Wells, San Carlos, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/491,220

(22) Filed: Jul. 20, 2006

(51) Int. Cl. G06Q 40/00

(52) U.S. Cl. 705/42

(57) ABSTRACT

A report is presented that summarizes transaction data. The report functions as an input mechanism as well as an output mechanism. The user can interact with the report directly, to add, edit, or delete transactions. Underlying transaction data is updated based on the user's input. The report is updated as well, to reflect the changes made as a result of the user's input.

### BACKGROUND

The present invention relates to user interfaces for generating reports and accepting user input in financial software applications.

Financial software applications include functionality for inputting and/or editing transaction data and viewing reports based on the input data. For example, a user can enter and/or edit transactions in a transaction register, and can then see a report showing spending in various categories over some period of time. In some cases, such reports can be quite sophisticated, including various types of categorization, filtering, subtotaling, and the like.

Typically, however, such reports constitute an output mechanism only. The user cannot generally edit the contents of such reports and thereby cause underlying transaction data to be changed. For example, if a report is generated showing a set of transactions categorized as “dining”, the user determines, from examining the report, that one or more transactions have been incorrectly categorized, the user cannot change the category a transaction by direct interaction with the report itself. Rather, the user must return to a register (or other input interface) to edit the transaction and thereby change its category. The user can then return to the report (and in some cases may have to refresh the report) to see the results of the change.

Accordingly, in most financial software applications, transaction input/edit operations are performed as a separate step from report generation and display. A user attempting to perform an input or edit operation in response to information he or she sees in a report is required to switch between these two separate parts of the software application.

### SUMMARY

In various embodiments, the present invention provides methods and systems for accepting user input within a displayed report, for inputting and/or editing transactions in a financial software application. An input area is displayed within or alongside a displayed report; the user can interact with this input area to change amounts, categories, dates, payees, and/or other information for one or more transactions. In one aspect of the invention, the user can also add new transactions and/or delete transactions from the report screen as well. All such changes, additions, and deletions are reflected in the displayed report, so that the user can obtain virtually immediate feedback showing the effects of his or her actions.

In one aspect of the present invention, the user can select, or highlight, certain report elements. The input area is updated accordingly to show transactions corresponding to the selected report element(s). In this way, the report itself can be used as a tool to filter and navigate among transactions for input purposes. For example, if a user selects a report element corresponding to a dining category, the input area provides access to dining transactions; if the user then selects a report element corresponding to an entertainment category, the input area provides access to entertainment transactions.

The report elements can also be used as input elements for changing the characteristics of transactions. For example, a user can re-categorize a dining transaction into an entertainment transaction by dragging the transaction from the input area onto an entertainment report element. In this manner, the present invention provides full integration and interoperability among different areas of the report.

The present invention can be implemented in connection with graphical reports such as bar graphs, pie charts, and the like. It can also be implemented in connection with tabular and/or text-based reports.

### BRIEF DESCRIPTION OF THE DRAWINGS

FIG. 1 is a flowchart depicting a method of the present invention according to one embodiment.

FIG. 2 is a block diagram depicting an architecture for practicing the present invention according to one embodiment.

FIG. 3 is an example of an interactive report including bar graphs, according to one embodiment of the present invention.

FIG. 4 is an example of an interactive report including a pie chart showing spending by category, according to one embodiment of the present invention.

FIG. 5 is an example of an interactive report including pie charts showing spending by payee, according to one embodiment of the present invention.

FIG. 6 is an example of an interactive report including a table showing spending by category, according to one embodiment of the present invention.

FIG. 7A is an example of an interactive report in the process of accepting user input within an input area.

FIG. 7B is an example of the interactive report of FIG. 7A, updated to reflect the user input.

FIG. 8 is an example of an interactive report including fields and controls for adding a new transaction.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

According to one embodiment, the present invention provides reports that can be used for input as well as output. A report is displayed. User input is received in connection with the displayed report. Based on the user input, transactions are added, deleted, and/or modified and the displayed report is updated accordingly.

The invention is described herein in the context of a personal financial software application that includes the capability of generating reports based on transactions and other financial data. For example, the functionality described herein can be implemented as a feature of a software application such as Quicken, available from Intuit Inc. The transactions and other data can be user-entered or can be received from another source, or can be a combination of both. Although the invention is described in such a context, one skilled in the art will recognize that the techniques and principles described herein have wide applicability in other contexts as well. For example, the present invention can be implemented in web-based applications, websites, locally-run software applications, or any combination thereof.

Accordingly, the specifics of the exemplary embodiments described herein are intended to be illustrative and are not intended to limit the scope of the invention.

Furthermore, the particular arrangements of elements in screen shots and reports shown here are illustrative of one embodiment and are not intended to limit the scope of the present invention.

### Architecture

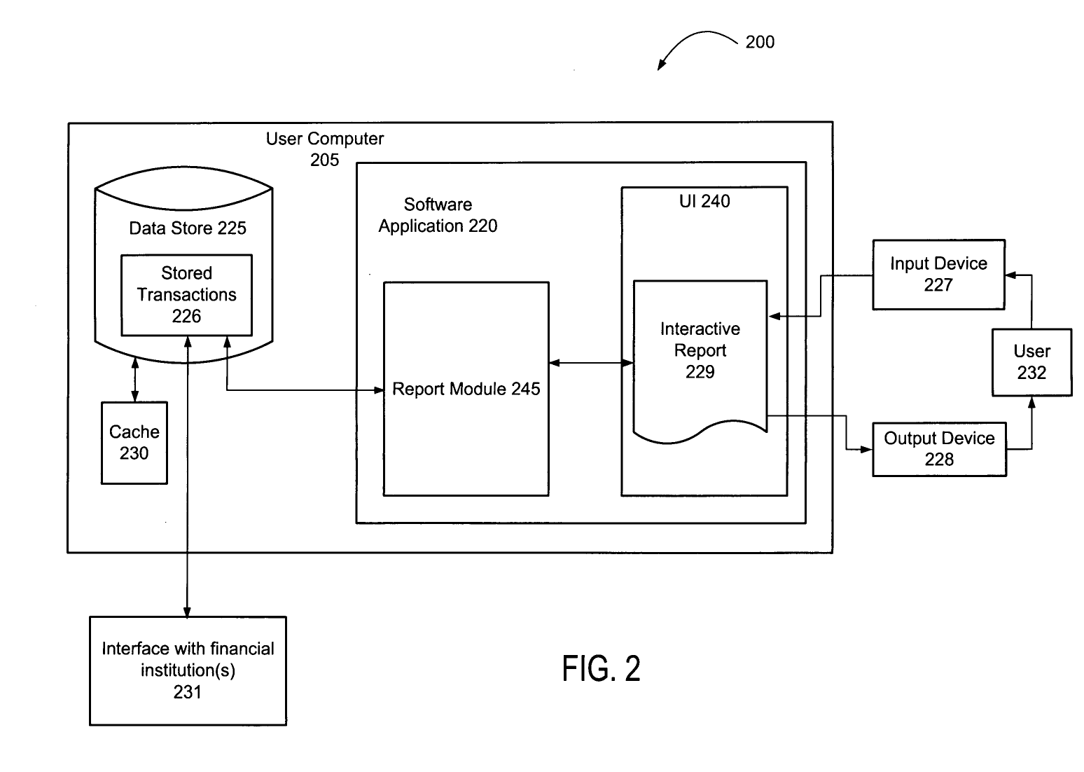

FIG. 2 is a block diagram illustrating the architecture of one embodiment of a system 200 useful for supporting a software application 220 for generating interactive reports. In such a system 200, there is provided at least one user computer 205, which may be a stand-alone device or may be communicatively coupled to a network (not shown) and/or one or more third party computers (not shown).

The user computer 205 is of conventional design, and includes a processor, an addressable memory, and other conventional features (not illustrated) such as a display, local memory, input/output ports, and a network interface. In other embodiments one or more of the components of the user computer 205 may be located remotely and accessed via a network. The network may be a wired or wireless network. Examples of the network include public networks, private networks, Internet, an intranet, a cellular network, or a combination thereof, or other system or method enabling digital communication between two or more computing systems.

The network interface and a network communication protocol provide access to a network and other computers, such as other user computers or third party computers, along with access to the Internet, via a TCP/IP type connection, or to other network embodiments, such as a LAN, a WAN, a MAN, a wired or wireless network, a private network, a virtual private network, or other networks. In various embodiments the user computer 205 may be implemented on a computer running a Microsoft operating system, Mac OS, various flavors of Linux, UNIX, Palm OS, and/or other operating systems.

The third party computers, if present, also may be computer systems, similar to the user computer described above. For example, one embodiment of a third party computer is a financial institution computer system, which provides transactions processing and clearing functionality for user software. The financial institution could be a securities brokerage company, a bank or credit union, a credit card company, or financial institutions. In this embodiment, the user software application 220 described herein may be a financial management software package capable of communicating with the financial institution computer system to access information from pre-existing user accounts (e.g., obtain account balances to determine available funds), and provide payment instructions for making payments to vendors.

The user computer 205 includes a software application 220, data store 225, and data cache 230. The software application 220 includes a number of executable code portions and data files. These include code for creating and supporting a user interface 240 according to one embodiment of the present invention, as well a report module 245 for generating interactive reports according to the techniques described herein. In other embodiments, the software application 220 can also be implemented as a stand-alone application outside of a financial management software package.

Data store 225 includes stored transactions 226. In one embodiment, transactions 226 are stored locally at user computer 205. In another embodiment, transactions 226 are stored at some other location, such as for example a remote server associated with a financial institution or other entity. In such an embodiment, report module 245 retrieves transaction data from the remote source as needed for generating reports 229, and transmits modified transaction data back to the remote source when appropriate. Such communications can take place using known network communication protocols across any known communication medium.

The software application 220 is responsible for orchestrating the processes performed according to the methods of the present invention. The software application 220 includes report module 245 for generating interactive reports 229 according to one embodiment of the present invention.

The report module 245 enables the system 200 to generate and present interactive reports 229 that are presented to user 232 via output device 228. In one embodiment, report module 245 operates within the context of user interface 240. The report module 245 is one means for generating interactive reports according to the present invention.

The above-described software portions need not be discrete software modules. The software configuration shown is meant only by way of example; other configurations are contemplated by and within the scope of the present invention.

The software application 220 may be provided to the user computer 205 on a computer readable media, such as a CD-ROM, diskette, or by electronic communication over a network from a third party computer or other distributors of software, for installation and execution thereon. Alternatively, the software application 220, data store 225, and data cache 230 can be hosted on a server computer, and accessed over a network, using for example a browser interface to the software application 220.

The data store 225 may be a relational database or any other type of database that stores the data used by the software application 220, for example account information in the financial management application embodiment referenced above. The data store 225 may be accessible by the software application 220 through the user interface 240. Some data from the data store 225 may be added to the data cache 230 upon initialization of the software application 220. The software application 220 and the data store 225 may be stored and operated on a single computer or on separate computer systems communicating with each other through a network.

The data cache 230 is a standard cache of small, fast memory holding recently accessed data. The data cache 230 may include, for example, transaction data to be used by report module 245 according to one embodiment of the present invention.

One skilled in the art will recognize that the system architecture illustrated in FIG. 2 is merely exemplary, and that the invention may be practiced and implemented using many other architectures and environments.

### Method

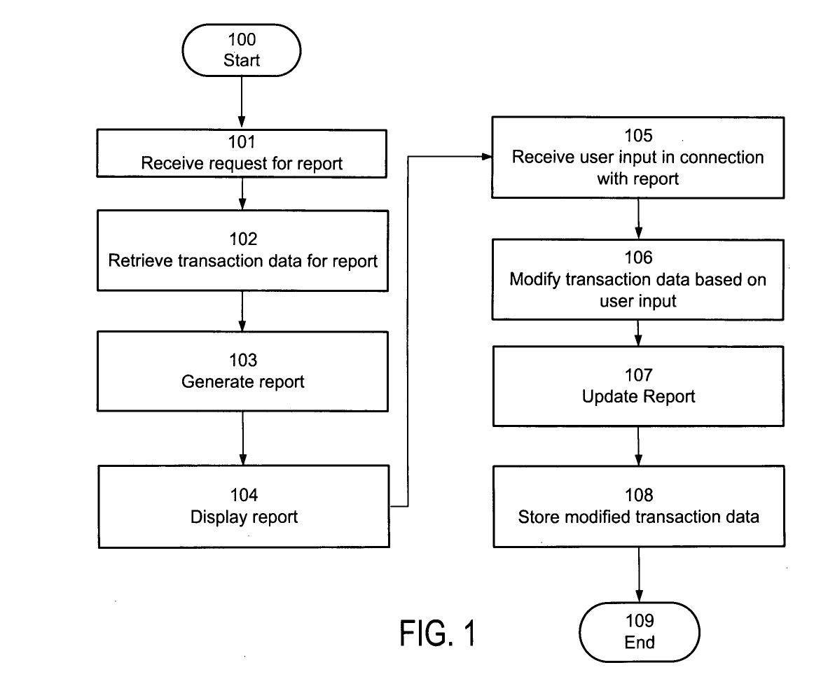

Referring now to FIG. 1, there is shown a method for practicing the present invention according to one embodiment. In one embodiment, the steps of FIG. 1 are performed by a system component such as report module 245 described above in connection with FIG. 2. In other embodiments, the steps of FIG. 1 are performed by other components, entities, or software. For illustrative purposes, the method of FIG. 1 will be described in the context of steps being performed by report module 245.

Report module 245 receives 101 a request for a report. For example, user 232 may activate a command that invokes a report request. Alternatively, a report may be generated automatically based on certain actions or transaction entries by the user. Parameters and characteristics for the report may be specified explicitly, or based on defaults, or they may be determined automatically based on the context in which the report was requested.

Most reports present transaction data of some kind. Accordingly, upon receiving the report request, report module 245 retrieves 102 transaction data for the report. In some cases, such transaction data can be obtained from stored transactions 226 at data store 225 located locally or remotely with respect to user computer 205. Transaction data may also be retrieved from cache 230 if it is available there.

Based on the specified parameters and retrieved transaction data, report module 245 generates 103 a report. The report is displayed 104 for user 232, for example via UI 240.

According to the techniques of the present invention, the displayed report is an interactive report 229. Thus, in addition to providing information to user 232, interactive report 229 provides a mechanism for receiving input from user 232 via input device 227. Report module 245 receives 105 user input in connection with the displayed interactive report 229. For example, the received input may indicate that the user would like to add a transaction, edit an existing transaction, or delete a transaction.

Based on the user input, report module 245 modifies transaction data. The displayed interactive report 229 is updated 107 accordingly, and the modified transaction data is stored 108, for example in stored transactions 226 area of data store 225.

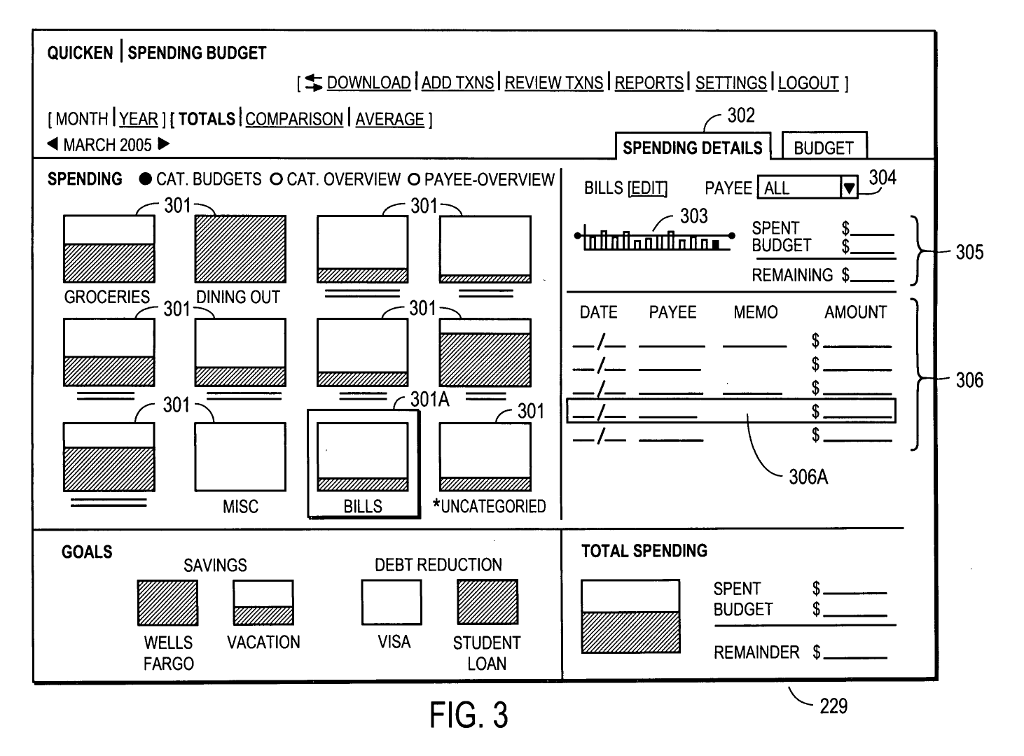

Referring now to FIG. 3, there is shown an example of an interactive report 229. A set of bar graphs 301 shows, in graphical form, an amount of spending in various categories. The user can click on any bar graph 301 to see detailed information in spending details section 302 of interactive report 229. In the example, the user has clicked on bar graph 301A representing a bills category. Accordingly, bar graph 301A is highlighted, and spending details section 302 shows information about the bills category. Time-series bar graph 303 shows historical spending, and budget comparison 305 provides a comparison between a budgeted amount and an actual amount. Interactive report 229 also shows, in spending details section 302, a list of transactions 306 having a bills category. If the user clicks on a different bar graph 301, spending details section 302 lists transactions 306 having a category associated with the bar graph 301 selected by the user.

The user can specify whether spending details section 302 should include transactions for all payees or some subset of payees by making the appropriate selection from payee menu 304. One skilled in the art will recognize that other types of information can be provided in spending details section 302.

The user can select a transaction 306A that is displayed in spending details section 302, and can make changes to the selected transaction 306A. For example, the user can change a date, payee, memo, or amount for transaction 306A, by selecting the transaction 306A, typing the changes, and pressing Enter or Return. The user can delete a selected transaction 306A by hitting a delete key; in one embodiment the user can make multiple selections and delete all selected transactions 306 with one keystroke. In one embodiment, the user can add a new transaction 306 by interacting with spending details section 302.

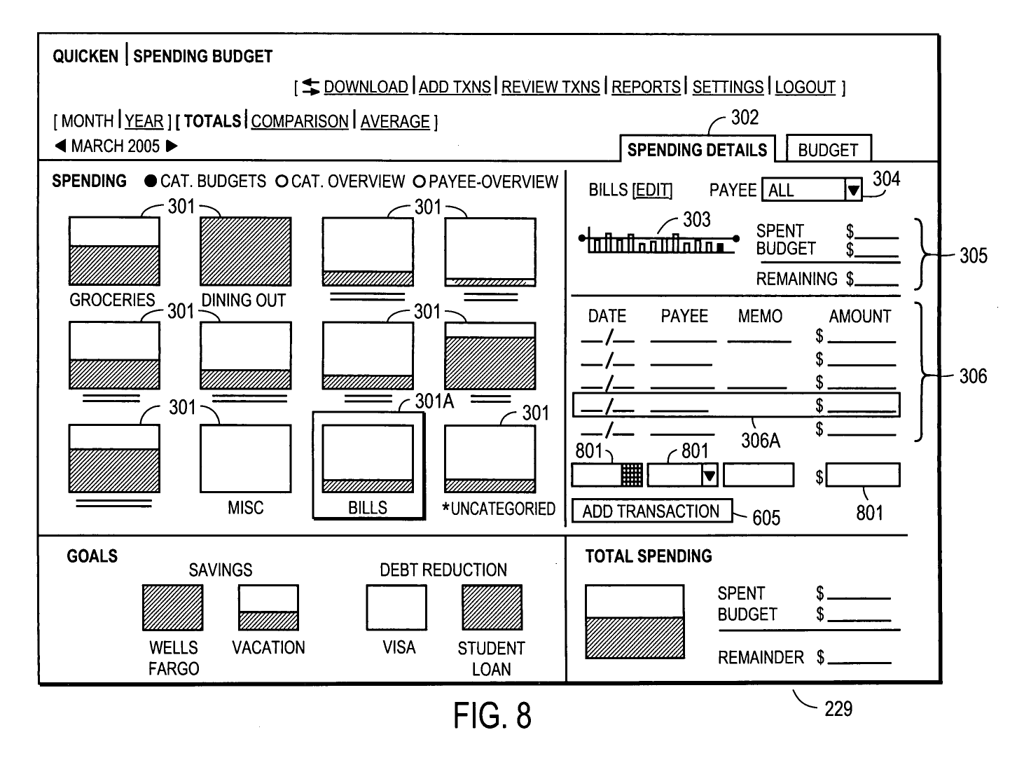

Referring now to FIG. 8, there is shown an example of an interactive report 229 including fields and controls for adding a new transaction. FIG. 8 is similar to FIG. 3, but also includes fields 801 for entry of a new transaction, and add transaction button 605. The user can add a transaction by filling in fields 801 (including for example, date, amount, payee, and the like), and clicking on add transaction button 605. In one embodiment, the new transaction has an initial category that matches the category currently displayed in spending details section 302; thus, in the example of FIG. 8, the new transaction would be assigned to the bills category. The user is able to change this default category if desired.

One skilled in the art will recognize that other mechanisms and user interfaces can be used for adding new transactions in the context of interactive report 229.

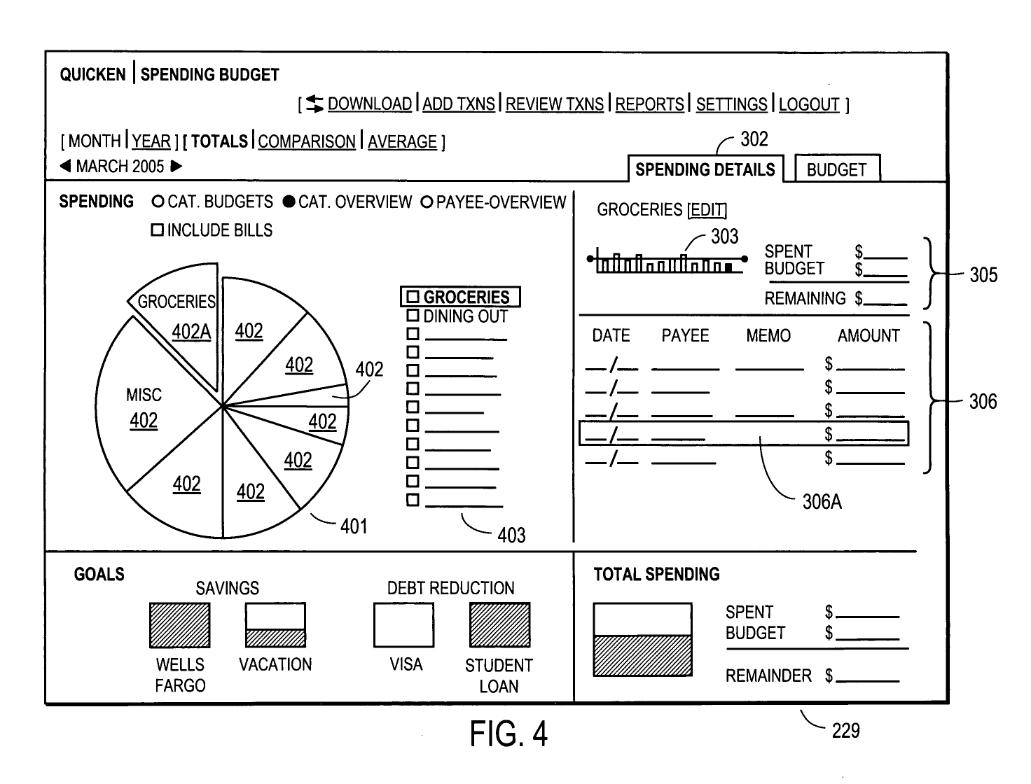

Referring now to FIG. 4, there is shown another example of an interactive report 229. Here, a pie chart 401 is presented, with segments 402 indicating relative spending in various categories. In one embodiment, pie chart 401 is color-coded; legend 403 helps the user identify the categories. The user can click on any segment 402 to see detailed information in spending details section 302 of interactive report 229. In the example, the user has clicked on segment 402A representing a groceries category. Accordingly, segment 402A is highlighted, and spending details section 302 shows information about the groceries category. Spending details section 302 operates in a manner similar to that described above in connection with FIG. 3, including the interactive features that allow a user to enter, change, or delete transactions directly within interactive report 229.

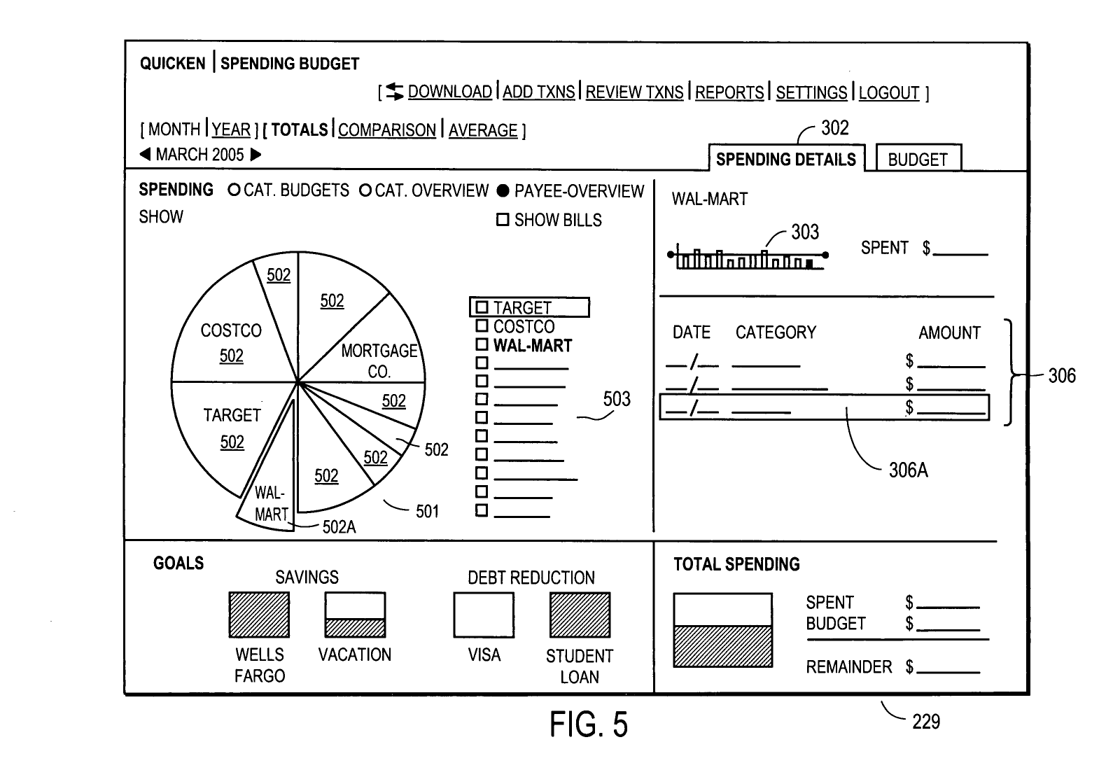

Referring now to FIG. 5, there is shown another example of an interactive report 229. Here, a pie chart 501 is presented, with segments 502 indicating relative spending to various payees. In one embodiment, pie chart 501 is color-coded; legend 503 helps the user identify the payees. The user can click on any segment 502 to see detailed information in spending details section 302 of interactive report 229. In the example, the user has clicked on segment 502A representing Wal-Mart. Accordingly, spending details section 302 shows information about transactions where the payee is Wal-Mart. Spending details section 302 operates in a manner similar to that described above in connection with FIG. 3, including the interactive features that allow a user to enter, change, or delete transactions directly within interactive report 229.

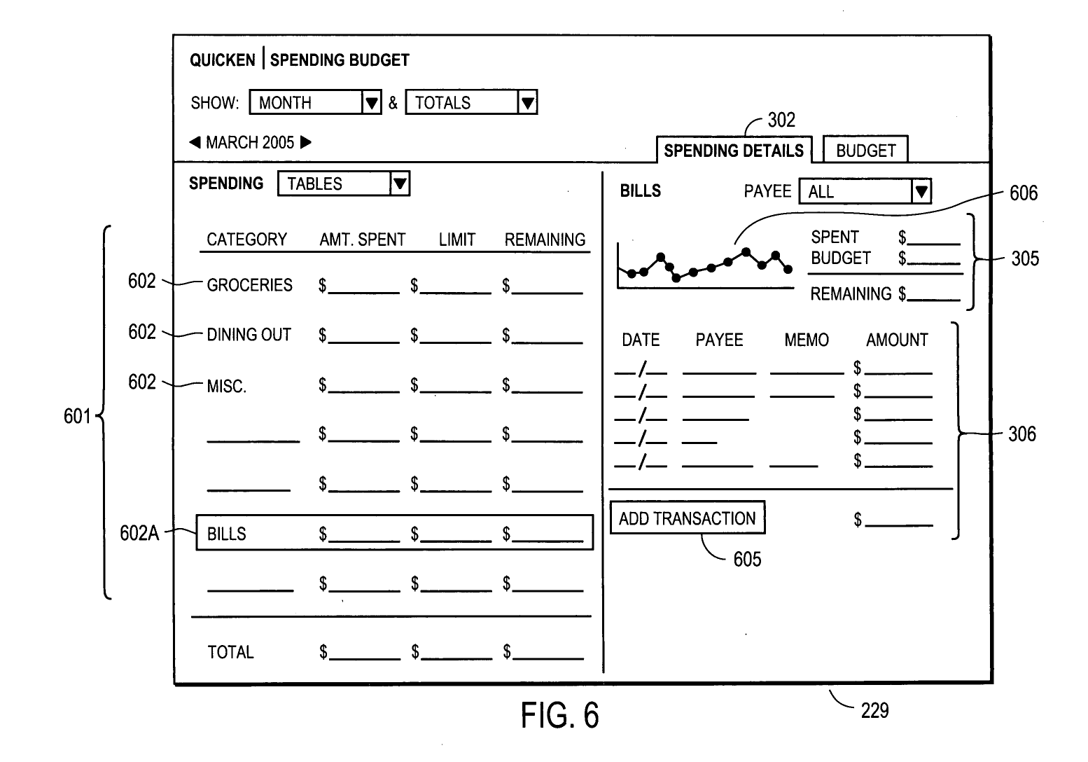

Referring now to FIG. 6, there is shown another example of an interactive report 229. Here, a table 601 is presented, with rows 602 indicating relative spending in various categories. The user can click on any row 602 to see detailed information in spending details section 302 of interactive report 229. In the example, the user has clicked on segment 602A representing bills. Line graph 606 summarizing bill spending over time. Budget comparison 305 is provided, as described above. Accordingly, spending details section 302 shows information about transactions where the category is bills. Interactive report 229 also shows, in spending details section 302, a list of transactions 306 having a bills category. Spending details section 302 operates in a manner similar to that described above in connection with FIG. 3, including the interactive features that allow a user to enter, change, or delete transactions directly within interactive report 229. In one embodiment, an add transaction button 605 is provided, which allows the user to add a new transaction directly within interactive report 229.

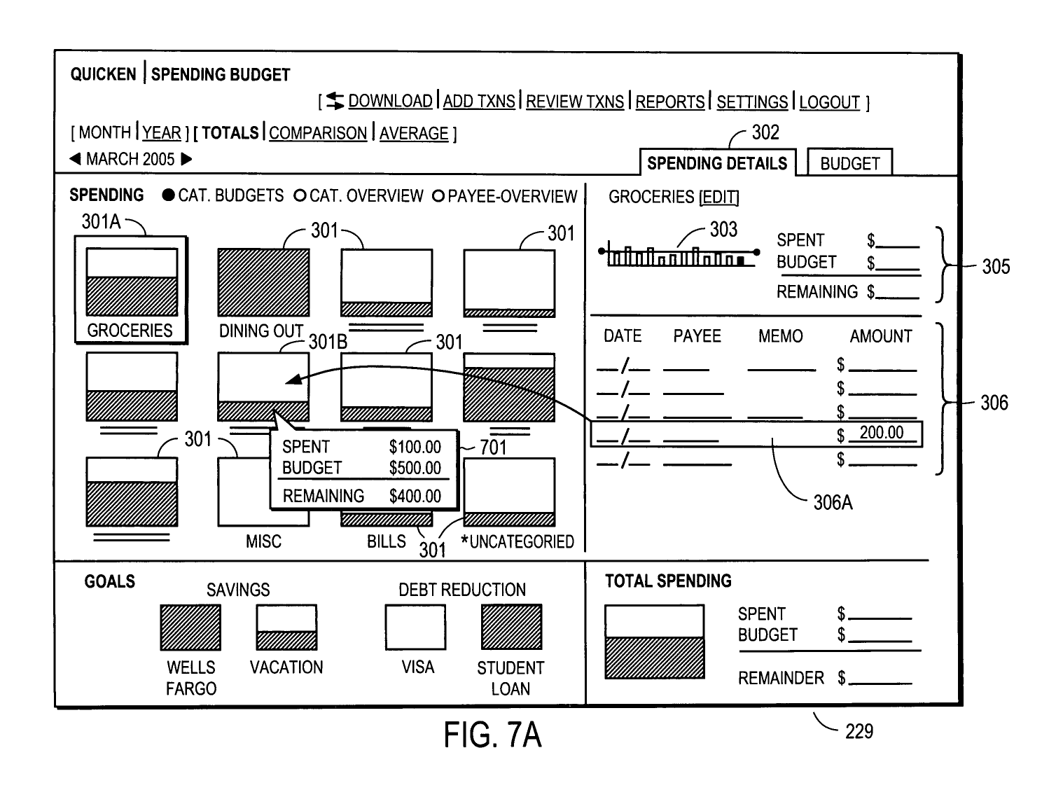

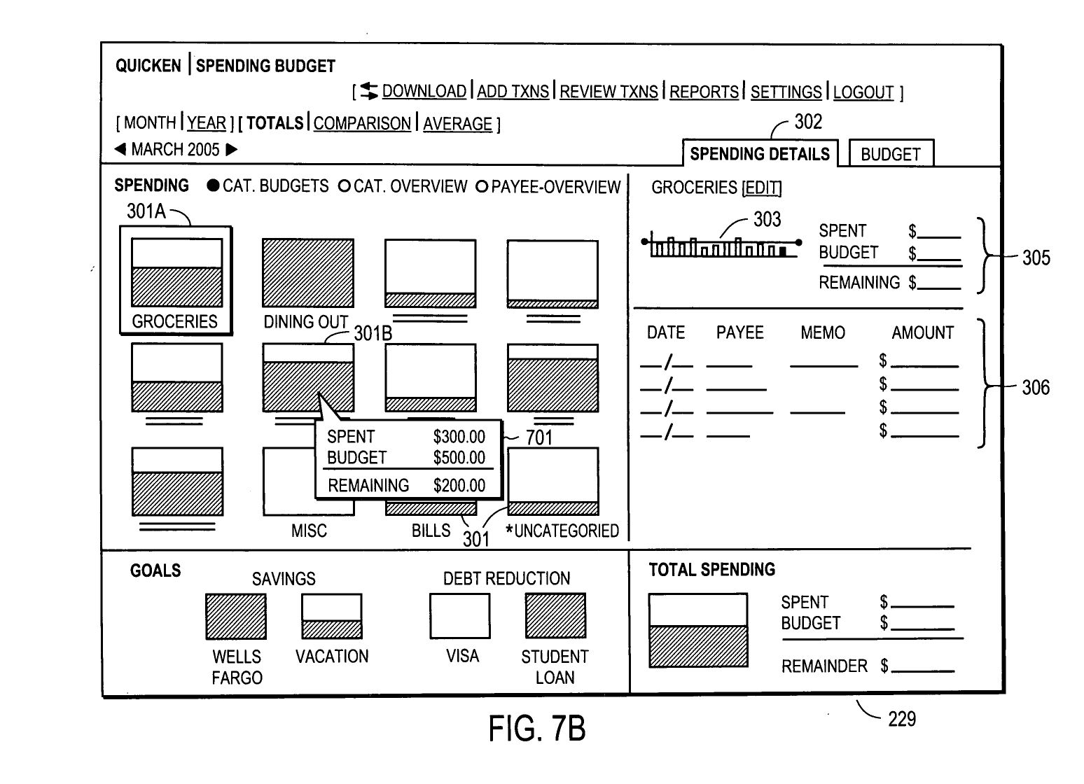

Referring now to FIG. 7A, there is shown an example of an interactive report in the process of accepting user input within an input area. In the example, the user has clicked on bar graph 301A representing a groceries category. Accordingly, bar graph 301A is highlighted, and spending details section 302 shows information about the bills category. Time-series bar graph 303 shows historical spending, and budget comparison 305 provides a comparison between a budgeted amount and an actual amount. Interactive report 229 also shows, in spending details section 302, a list of transactions 306 having a groceries category.

In the example, the user wishes to change the category of transaction 306A to a category other than groceries. One mechanism for doing so is to drag transaction 306A to a bar graph 301 representing the desired category. In the context of an interactive report 229 as provided by the present invention, such a user action causes the dragged transaction 306A to be recategorized.

In FIG. 7A, the user is dragging transaction 306A to bar graph 301B, which represents a category other than groceries. In one embodiment, pop-up box 701 appears while the cursor is positioned over bar graph 301B, to show data relating to the category associated with bar graph 301B. Such data includes, for example, total amount spend, budget, and remainder.

FIG. 7B is an example of the interactive report of FIG. 7A, after the user has released the mouse button to complete the drag-and-drop operation that results in recategorization of transaction 306A. In FIG. 7A, interactive report 229 has been updated to reflect the fact that transaction 306A is no longer categorized as a groceries transaction. Transaction 306A no longer appears within spending details section 302. Bar graph 303 and budget comparison 305 have been updated to reflect the removal of transaction 306A from the groceries category. Similarly, bar graphs 301A and 301B have also been updated to reflect the recategorization of transaction 306A. Also, pop-up box 701 has been updated to include the amount of transaction 306A.

Accordingly, as shown in FIGS. 7A and 7B, interactive report 229 provides a mechanism for recategorizing transactions by performing drag-and-drop operations directly within report 229.

The techniques of the present invention can also be implemented in connection with other types of reports, including any other type of graphical and/or non-graphical (tabular and/or text-based) report.

The present invention thus allows a user to make changes to transactions, and/or to add and delete transactions, directly from a displayed report. This saves time and effort, since the user does not have to return to a transaction register or other entry/edit screen and then re-run the report to see the results of his or her changes. The interactive report of the present invention thus provides an efficient mechanism for presenting transaction data to the user and receiving transaction input from the user.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for displaying an interactive report for a financial software application, comprising:
displaying a report based on transaction data describing a plurality of transactions, the report comprising at least one input element;
receiving user input within an input element of the report; and
responsive to the received user input:
modifying the transaction data as indicated by the received user input;
storing the modified transaction data;
updating the report based on the modified transaction data; and
displaying the updated report.

2. The method of claim 1, wherein modifying the transaction data comprises adding a new transaction.

3. The method of claim 2, wherein receiving user input comprises receiving data for the new transaction.

4. The method of claim 1, wherein modifying the transaction data comprises editing a transaction.

5. The method of claim 1, wherein modifying the transaction data comprises recategorizing a transaction.

6. The method of claim 5, wherein a transaction is associated with a first category, and wherein receiving user input comprises receiving user input dragging the transaction to a report element associated with a second category.

7. The method of claim 1, wherein modifying the transaction data comprises deleting a transaction.

8. The method of claim 1, further comprising:
prior to displaying the report, retrieving the transaction data from a data store;
and wherein storing the modified transaction data comprises storing the modified transaction data in the data store.

9. The method of claim 1, wherein the input element comprises a data entry field.

10. The method of claim 1, wherein the report comprises at least one graphical element.

11. The method of claim 1, wherein the report comprises at least one table.

12. The method of claim 1, wherein the report comprises at least one text element.

13. A method for displaying an interactive report for a financial software application, comprising:
displaying at least one report element representing data representing a plurality of transactions belonging to a category;
receiving user input selecting a displayed report element;
displaying an interactive input area comprising transactions associated with the selected report element;
receiving user input modifying at least one transaction in the displayed interactive input area; and
updating at least one report element to reflect the modified transaction.

14. A computer program product for displaying an interactive report for a financial software application, comprising:
a computer-readable medium; and
computer program code, encoded on the medium, for:
displaying a report based on transaction data describing a plurality of transactions, the report comprising at least one input element;
receiving user input within an input element of the report; and
responsive to the received user input:
modifying the transaction data as indicated by the received user input;
storing the modified transaction data;
updating the report based on the modified transaction data; and
displaying the updated report.

15. The computer program product of claim 14, wherein the computer program code for modifying the transaction data comprises computer program code for adding a new transaction.

16. The computer program product of claim 15, wherein the computer program code for receiving user input comprises computer program code for receiving data for the new transaction.

17. The computer program product of claim 14, wherein the computer program code for modifying the transaction data comprises computer program code for editing a transaction.

18. The computer program product of claim 14, wherein the computer program code for modifying the transaction data comprises computer program code for recategorizing a transaction.

19. The computer program product of claim 18, wherein a transaction is associated with a first category, and wherein the computer program code for receiving user input comprises computer program code for receiving user input dragging the transaction to a report element associated with a second category.

20. The computer program product of claim 14, wherein the computer program code for modifying the transaction data comprises computer program code for deleting a transaction.

21. The computer program product of claim 14, further comprising computer program code for:
prior to displaying the report, retrieving the transaction data from a data store;
and wherein the computer program code for storing the modified transaction data comprises computer program code for storing the modified transaction data in the data store.

22. The computer program product of claim 14, wherein the input element comprises a data entry field.

23. The computer program product of claim 14, wherein the report comprises at least one graphical element.

24. The computer program product of claim 14, wherein the report comprises at least one table.

25. The computer program product of claim 14, wherein the report comprises at least one text element.

26. A computer program product for displaying an interactive report for a financial software application, comprising:
a computer-readable medium; and
computer program code, encoded on the medium, for:
displaying at least one report element representing data representing a plurality of transactions belonging to a category;
receiving user input selecting a displayed report element;
displaying an interactive input area comprising transactions associated with the selected report element;
receiving user input modifying at least one transaction in the displayed interactive input area; and
updating at least one report element to reflect the modified transaction.

27. A system for displaying an interactive report for a financial software application, comprising:
a data store, for storing transaction data describing a plurality of transactions;
a report module, for generating a report based on the stored transaction data, the report comprising at least one input element;
a display device, for displaying the report; and
an input device, for receiving user input within an input element of the report, the user input indicating a modification to the transaction data;
wherein, responsive to the received user input:
the data store stores modified transaction data as indicated by the user input;
the report module updates the report based on the modified transaction data; and
the display device displays the updated report.

28. The system of claim 27, wherein the input device receives user input indicating that a new transaction is to be added.

29. The system of claim 28, wherein the input device receives data for the new transaction.

30. The system of claim 27, wherein the input device receives user input indicating an edit for a transaction.

31. The system of claim 27, wherein the input device receives user input indicating recategorization of a transaction.

32. The system of claim 31, wherein a transaction is associated with a first category, and wherein the input device receives user input dragging the transaction to a report element associated with a second category.

33. The system of claim 27, wherein the input device receives user input indicating deletion of a transaction.

34. The system of claim 27, wherein the input device receives user input within a data entry field.

35. The system of claim 27, wherein the report comprises at least one graphical element.

36. The system of claim 27, wherein the report comprises at least one table.

37. The system of claim 27, wherein the report comprises at least one text element.
